(19) United States
(12) Patent Application Publication
(10) Pub. No.: US 2011/0088170 A1
(43) Pub. Date: Apr. 21, 2011

(54) MAGNETIC ROOFING HATCHET

(75) Inventor: Matthew J. Crookston, Stow, OH (US)

(73) Assignee: AJC TOOLS & EQUIPMENT, Hudson, OH (US)

(21) Appl. No.: 12/903,729

(22) Filed: Oct. 13, 2010

Related U.S. Application Data
(60) Provisional application No. 61/251,972, filed on Oct. 15, 2009.
(60) Provisional application No. 61/326,763, filed on Apr. 22, 2010.

(51) Int. Cl. E04D 15/00; B26B 23/00; B25D 1/00

(52) U.S. Cl. 7/122; 30/308.1; 81/45; 7/145

(57) ABSTRACT

A hatchet head for a roofing tool includes a hammering end having a striking face and a first bore formed in the striking face. The hatchet head also comprises a magnet assembly disposed within the first bore, where the magnet assembly includes a magnet and a cover having a uniform diameter along its length. The cover is configured to retain the magnet within the first bore. Additionally, the hatchet head includes a multi-purpose end having a thickness and an elongated slot extends through the thickness. A gauging assembly is disposed through the elongated slot.

### CROSS-REFERENCE TO RELATED APPLICATIONS

This patent application claims the benefit of and priority to U.S. Provisional Patent Application Ser. No. 61/251,972 filed on Oct. 15, 2009 and U.S. Provisional Patent Application Ser. No. 61/326,763 filed on Apr. 22, 2010, the disclosures of which are expressly incorporated by reference herein in their entirety.

### TECHNICAL FIELD

The present invention relates to a roofing hand tool. More particularly, the invention relates to a magnetic roofing hatchet used for hammering, prying, hatcheting, cutting, starting nails, and removing nails.

### BACKGROUND OF THE INVENTION

The concept of providing roofing tools with multiple features and functions is well established. However, certain projects, such as roofing, building, construction, and demolition, still require multiple tools to accomplish various tasks. It is not uncommon for one, during the course of a project, to require a hammer, a hatchet, a nail starter, a nail remover, a pry bar, and/or a utility knife. To complete the project, one not only has to supply the various individual tools, but also has to transport these tools to the project location.

If a project requires one to work in an obscure location, such as a on roof, while standing on ladder, or in a crawl space, one must normally carry all necessary tools on their person. Carrying a plurality of tools can be cumbersome, inefficient, and, most of all, dangerous, as one must either travel back and forth to retrieve different tools or carry numerous tools in awkward situations, potentially causing harm to themselves and others.

### SUMMARY OF THE INVENTION

In one embodiment, a hatchet head for a roofing tool comprises a hammering end having a striking face and a first bore formed in the striking face. The hatchet head also comprises a magnet assembly disposed within the first bore including, where the magnet assembly includes a magnet and a cover having a uniform diameter along its length and retaining the magnet within the first bore. Additionally, the hatchet head comprises a multi-purpose end having a thickness and an elongated slot extends through the thickness. A gauging assembly may be disposed through the elongated slot.

The cover the cover further includes an outer face substantially coplanar with the striking face and forms at least a portion of the striking face. A bore may be formed in an inner face of the cover. Additionally, the cover may be frictionally fitted within the first bore.

Still further, a depression adapted to receive a blade may be formed on a first face of the multi-purpose end.

In another aspect, the hatchet head may further comprise a pry adjacent the striking face. In some cases, the pry may be integral with the hammering end.

In another embodiment, a roofing tool comprises a hatchet head having a first end including a striking face, a second end, a top side, a bottom side, a first bore formed in the top side and adjacent to the striking face, and a magnet assembly disposed within the first bore.

Additionally, a second bore dimensioned to receive a magnet may be formed and extend below the first bore. In one instance, a magnet may be disposed within the first bore. Alternatively or additionally, a magnet may be disposed within the second bore.

Additionally, the magnet assembly may include a cover adapted to retain a magnet within the first bore. Furthermore, a magnet receiving bore may be formed in an inner face of the cover. Additionally, the cover may be secured within the first bore in a friction fit relationship.

Still further, an aperture extending from the top side through the bottom side of the hatchet head. It is contemplated that a handle may be at least partially disposed within the aperture.

In still a further embodiment, a roofing tool comprises a hatchet head including a hammering end, a multi-purpose end, and an aperture formed through the hatchet head. The hammering end includes a striking face, a pry adjacent the striking face, a bore formed in the striking face, and a magnet assembly disposed within the bore. The magnet assembly includes a magnet and a cover retaining the magnet within the bore. Additionally, the cover has a uniform diameter along its length and an outer surface substantially coplanar with the striking face. Further, the multi-purpose end has an elongated slot and a depression formed therein. Still further, a handle is at least partially disposed in the aperture.

### BRIEF DESCRIPTION OF THE DRAWINGS

FIG. 1 shows a side view of a roofing tool, in accordance with one embodiment of the subject invention.

FIG. 2 shows a side view of one embodiment of a roofing hatchet head.

FIG. 3 shows the striking face of the roofing hatchet head shown in FIG. 2.

FIG. 4 shows a side view of an alternate embodiment of a roofing hatchet head.

FIG. 5 shows the striking face of the embodiment of the roofing hatchet head shown in FIG. 4.

FIG. 6 shows a side view of another alternate embodiment of a roofing hatchet head.

FIG. 7 shows the striking face of the embodiment of the roofing hatchet head shown in FIG. 6.

FIG. 8 shows a side view of the multi-purpose end of a roofing tool.

FIG. 9 shows the opposite side view of the multi-purpose end of a roofing tool shown in FIG. 8.

FIG. 10A shows a cross-sectional view of one embodiment of the magnetic holding mechanism of the roofing tool shown in FIG. 1 along the line A-A.

FIG. 10B shows a cross-sectional view of one embodiment of the magnetic holding mechanism of the roofing tool shown in FIG. 1 along the line B-B.

FIG. 11A shows a cross-sectional view of an alternate embodiment of the magnetic holding mechanism of the roofing tool shown in FIG. 1 along the line A-A.

FIG. 11B shows a cross-sectional view of one embodiment of the magnetic holding mechanism of the roofing tool shown in FIG. 1 along the line B-B.

FIG. 12 shows a side view of an alternate embodiment of a roofing head hatchet.

FIG. 13 shows a partial cross-sectional view of the embodiment of the roofing hatchet head shown in FIG. 12 along line 13-13.

FIG. 14 shows a cross-sectional view of the embodiment of the roofing hatchet head shown in FIG. 12 along line 14-14.

FIG. 15 shows a top view of the embodiment of the roofing hatchet head shown in FIG. 12.

FIG. 16 shows a top view of one embodiment of a roofing tool.

FIG. 17 shows a top view of a second embodiment of a roofing tool.

### DETAILED DESCRIPTION

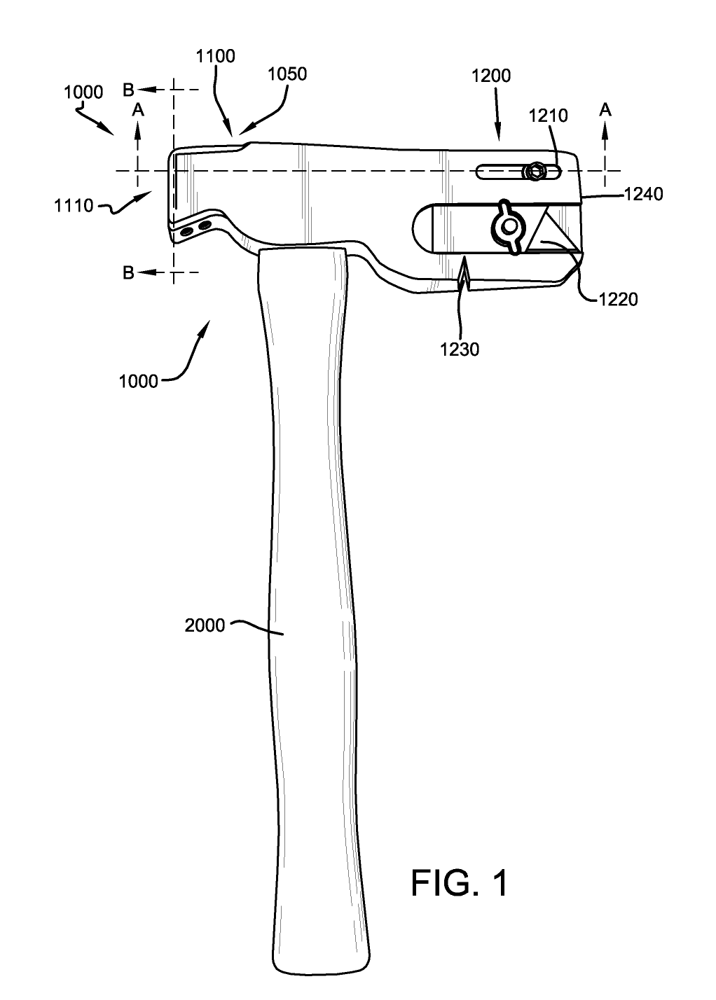

A roofing tool, generally identified by reference numeral 1000, is shown in the Figures. As shown in FIG. 1, the roofing tool 1000 comprises a roofing hatchet head 1050 having a first, hammering end 1100 and a second, multi-purpose end 1200. In construction, the roofing hatchet head 1050 may comprise hardened steel or any other suitable material, which may be formed into the desired shape by forging or casting, for example. It is also envisioned that the roofing tool 1000 may further include a handle 2000.

In one embodiment of the roofing hatchet head 1050, shown in FIGS. 1-3, the hammering end 1100 has a striking face 1110. Additionally, the multi-purpose end 1200 includes gauging mechanism 1210 which may be used to measure a predetermined distance from the edge 1240 of the multi-purpose end. The edge 1240 may be configured with a geometry designed for splitting materials such as roofing and siding materials, and more specifically, wooden shingles and wooden shakes. The multi-purpose end 1200 may in addition include cutting mechanism 1220 for cutting roofing material and a pulling mechanism 1230 comprising two angled, intersecting walls 1232, 1234 arranged in a V-shape configured to engage the shaft of a fastener embedded within a surface.

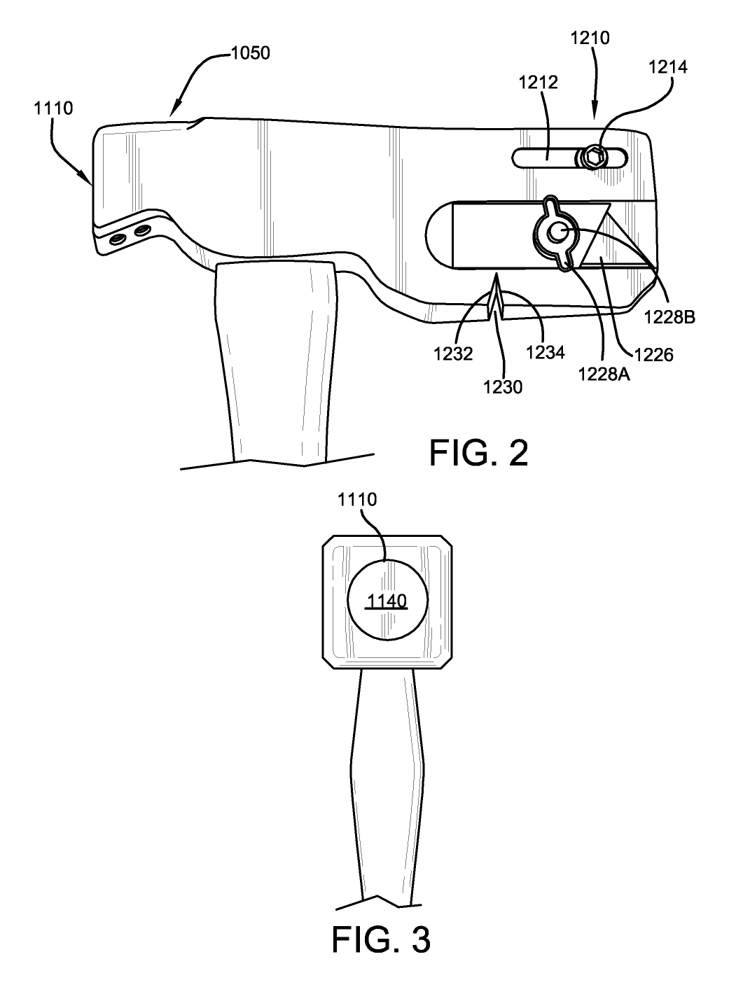

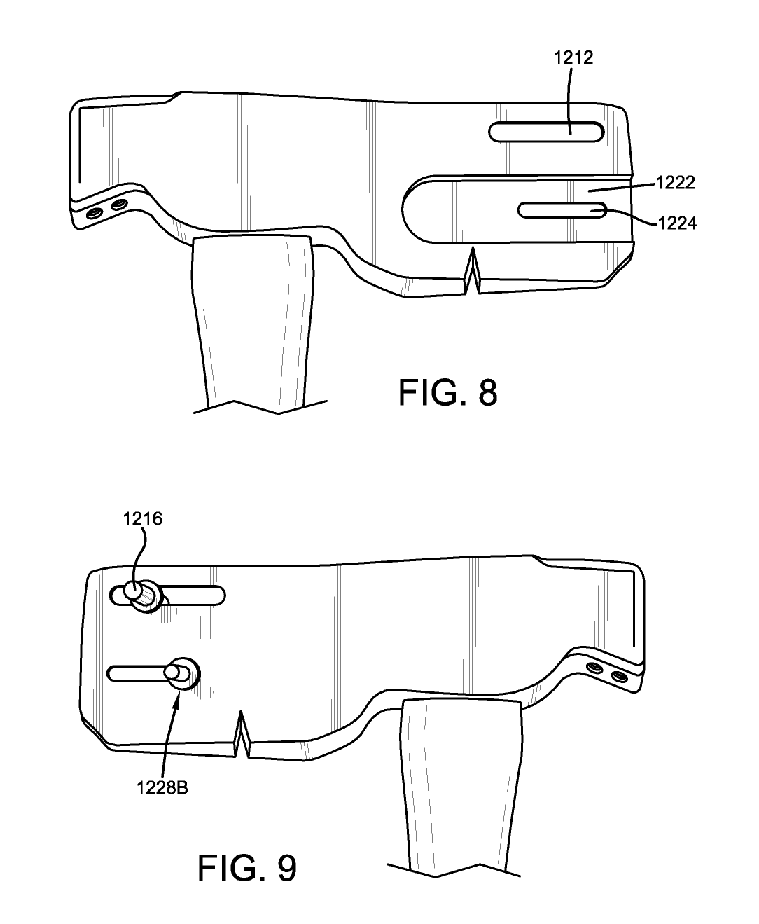

It is envisioned that the gauging mechanism 1210 is selectively adjustable and positionable and may include a slot 1212, which is configured to receive the shaft of a bolt 1216, as shown in FIGS. 2, 8, and 9. The shaft of the bolt 1216 may be configured to threadingly engage a nut 1214. Optionally, a washer may be placed between the head of bolt 1216 and the face of multi-purpose end 1200. As such, a user may loosen the nut 1214, thereby permitting the bolt 1216 to slide within the length of the slot 1212 to a pre-determined distance from the edge 1240. Once the desired distance between the head of the bolt 1216 and the edge 1240 is achieved, the nut 1214 may be tightened, thereby locking the bolt 1216 in place. This arrangement may permit a user to slide the edge 1240 under a shingle or shake to gauge or measure the spacing of the material on, for example, a roof.

Referring now to FIGS. 2, 8 and 9, the cutting mechanism 1220 comprises a recess or slotted depression 1222 formed on one face of the multi-purpose end 1200, with one end of the depression 1222 open at the edge 1240. The depression 1222 comprises a slot 1224 formed entirely within the depression which is configured to receive a threaded bolt 1228B. The bolt 1228B is adapted to threadingly engaged a nut 1228A. In one instance, the nut 1228A may be a wing-nut, although any other nut style may also be utilized to threadingly engage the bolt 1228B. The depression 1222 may be configured to receive substantially any commercially available utility blade 1226. In a preferred embodiment, the blade 1226 has an aperture therethrough. In assembly, then, the blade 1226 is placed in depression 1222, then the shaft of the bolt 1228B is passed through an aperture in the blade 1226 and slot 1224 and threadingly engaged with nut 1228A. Optionally, a washer may be placed between the surface of the blade 1226 and nut 1228A, as well as between the head of bolt 1228B and the face of the multi-purpose end 1200. Blade 1226 may be selectively extended beyond edge 1240 when a user desires to cut a material, or selectively withdrawn into depression 1222 when a user does not plan to cut a material. Once blade 1226 is positioned at the desired location, nut 1228A may be tightened, thereby locking the blade 1226 in place. While prior art nuts typically require tools for loosening and tightening, the wing-nut style nut 1228A may be tightened and loosened by hand, reducing the number of tools a user needs to carry to perform the desired task.

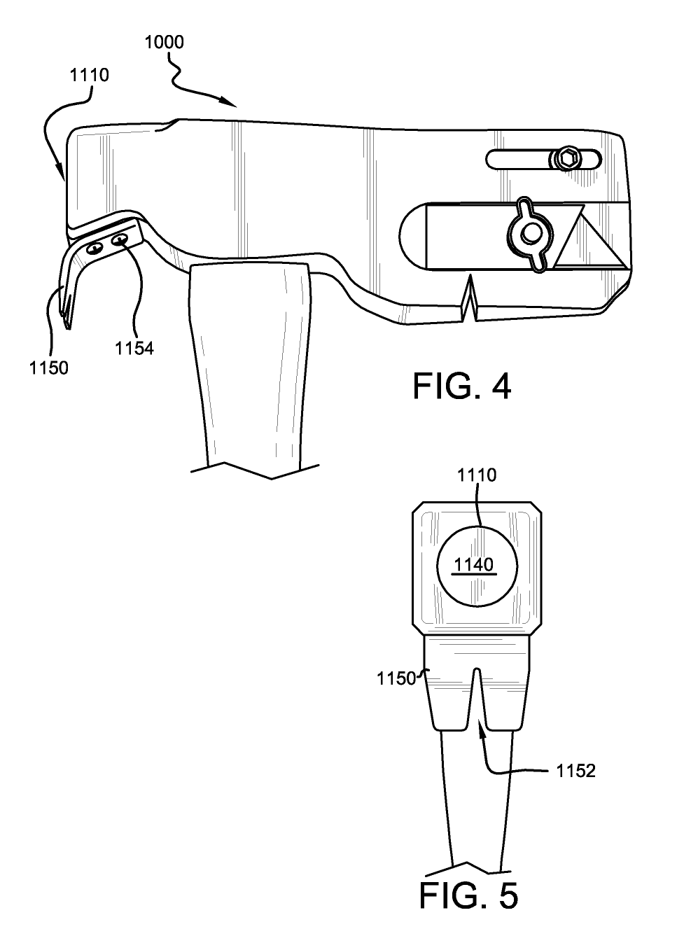

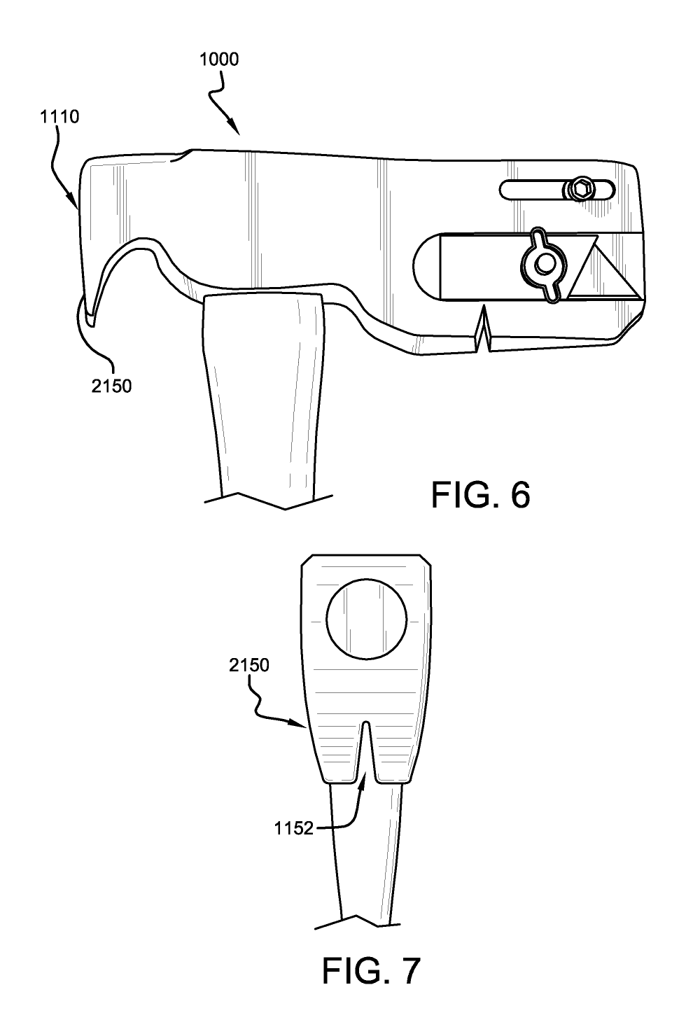

Turning now to FIGS. 4-7, it is envisioned that hammering end 1100 may optionally comprise a pry 1150 extending co-planarly from the striking face 1110. In one embodiment, the pry 1150 includes a notch 1152 configured to receive the shaft of a fastener embedded in a surface. The notch 1152 may be utilized for pulling an embedded fastener from a surface. The notch 1152 may be a polygonal shape, v-shaped, rounded, or any shape capable of pulling the embedded fastener from a material. Pry 1150 may be selectively attached to the hammering end 1100 by at least one fastener 1154. In another embodiment shown in FIGS. 6-7, the pry 2150 may be integrally formed as part of the hammering end or welded thereto.

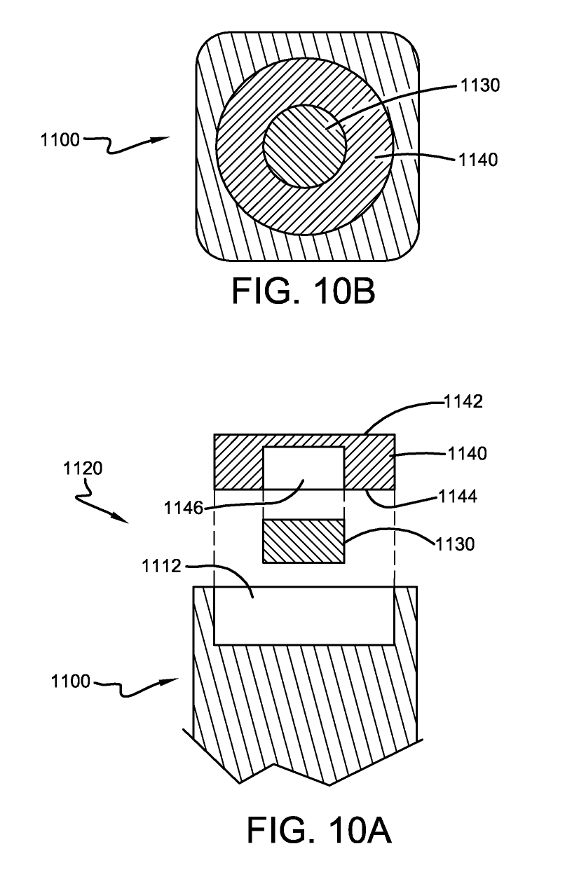

Referring now to FIGS. 10A and 10B, the hammering end 1100 further includes a magnetic holding mechanism 1120. In manufacture, a bore 1112 is formed in the hammering end 1100 and configured to receive a cover 1140 in a friction fit relationship. In a preferred embodiment, the cover 1140 has a height and diameter configured to fit within the bore 1112, and includes an outer surface or first end 1142. The cover 1140 is inserted into the bore 1112 such that the outer surface 1142 is flush or substantially coplanar with the portion of the striking face 1110 immediately adjacent the bore 1112. In this substantially coplanar arrangement, the outer surface 1142 forms a portion of the striking face 1110.

In a preferred embodiment, the cover 1140 has one uniform diameter and is configured to retain a magnet 1130 within the bore 1112. In one embodiment, a second bore 1146 is formed in the inner surface or second end 1144 of the cover 1140. The bore 1146 is configured to receive at least a portion of the magnet 1130. It is envisioned that the magnet 1130 may be cylindrical in shape and may have a diameter and height configured to fit within the second bore 1146, although other combinations of bore/magnet arrangements are also contemplated. As shown in FIGS. 10A and 10B, the magnet 1130 is received within bore 1146 and at least a portion of the inner surface 1144 is proximate an inner surface of the bore 1146. In composition, the magnet 1130 may be a rare-earth magnet, for example a neodymium magnet. Still further, it is contemplated that cover 1140 may be formed of the same material as the hatchet head 1050, for example hardened steel. However, it is also contemplated that cover 1140 may be formed of a relatively high hardness, non-magnetic material, such as titanium, austenitic nickel-chromium based superalloys, or roll-hardened stainless steel.

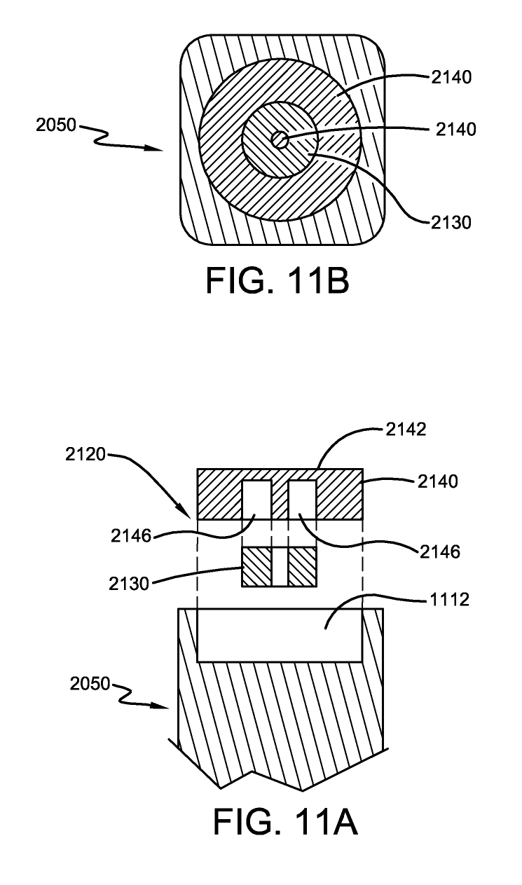

An alternate embodiment of the magnetic holding mechanism 2120 is shown in FIGS. 11A and 11B. A second bore 2146 formed in the cover 2140 is formed in the shape of a ring. As such, the magnet 2130 is also provided in a ring-shape corresponding to the shape of the annular second bore 2146. In either configuration, however, it is envisioned that magnet 1130, 2130 is magnetized in the direction of the longitudinal axis of the hatchet head 2050, thereby centering the head of a fastener on the striking face 1110.

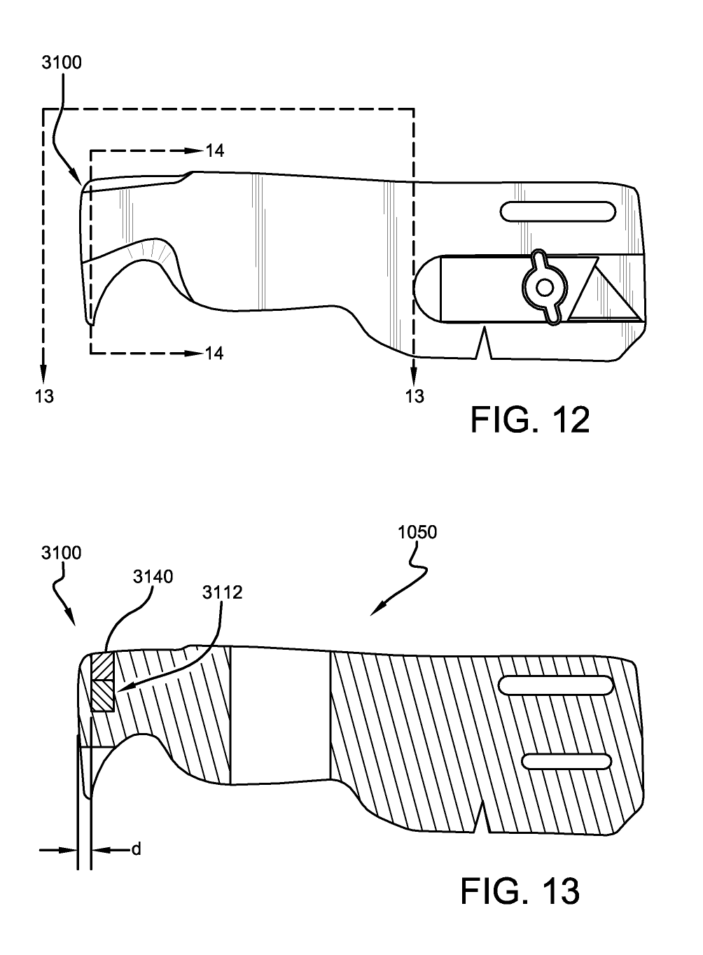

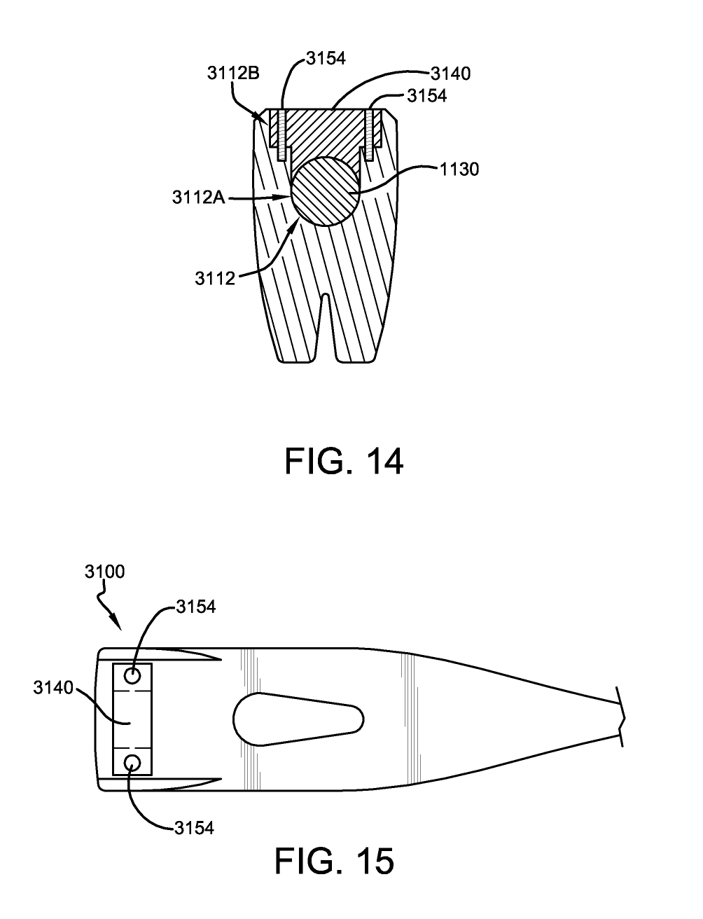

Referring now to FIGS. 12-15, an alternate embodiment of the hammering end 3100 is shown which includes a magnetic holding mechanism 3120. The magnetic holding mechanism 3120 comprises a bore 3112, a magnet 1130, and a cover 3140. As shown in FIG. 13-14, the bore 3112 is configured to receive the magnet 1130 and the cover 3140. In one embodiment, the bore 3112 includes a first portion 3112a configured to receive the magnet 1130 and a second portion 3112b configured to receive the cover 3140. It is also envisioned that the bore 3112 may include only one portion which is dimensioned to receive both a magnet and a cover.

As shown in FIG. 13, the bore 3112 may be formed within the top side of the hatchet head 1050 substantially adjacent to the striking face 3110. By substantially adjacent, it is meant that the bore 3112 is spaced back a distance from the striking face 3110 by some offset, d. This distance or offset may be determined by taking into account the mechanical and magnetic properties of the metal from which the hatchet head is formed in combination with the strength of the magnet to be received into the bore 3112. In that regard, the offset may be configured with consideration of whether the strength of the magnet will permit the magnetic flux to penetrate through the distance of the offset and center a fastener on the striking face, while maintaining the magnetization of the magnet and without deformation of the striking face during repeated use.

In one embodiment, the cover 3140 may be configured to be secured within the bore 3112 in a friction fit relationship. Alternatively or additionally, it is contemplated that the cover 3140 may be secured within the bore 3112 by other methods, such as by welding or by use of fasteners. For example, and as shown in FIGS. 14 and 15, the cover 3140 may be secured within the bore 3112 by one or more fasteners 3154. In one embodiment shown in FIG. 14, the cover 3140 may be substantially T-shaped, i.e., it may include a longitudinal portion and an intersecting transverse portion perpendicular thereto without preference to the relative lengths of the longitudinal and transverse portions. Alternatively, the cover 3140 may be dimensioned to correspond to and be secured within other configurations of the bore 3112. Regardless of the configuration of the bore 3112 and the magnet 1130, the cover 3140 is configured to secure the magnet within the bore during use of the roofing hatchet.

Still further, it is contemplated that the cover 3140 may be formed of the same material as the hatchet head 1050, which in one embodiment may be stainless steel. However, it is also contemplated that cover 1140 may be formed of other suitable materials, including without limitation, various grades of steel and other metals.

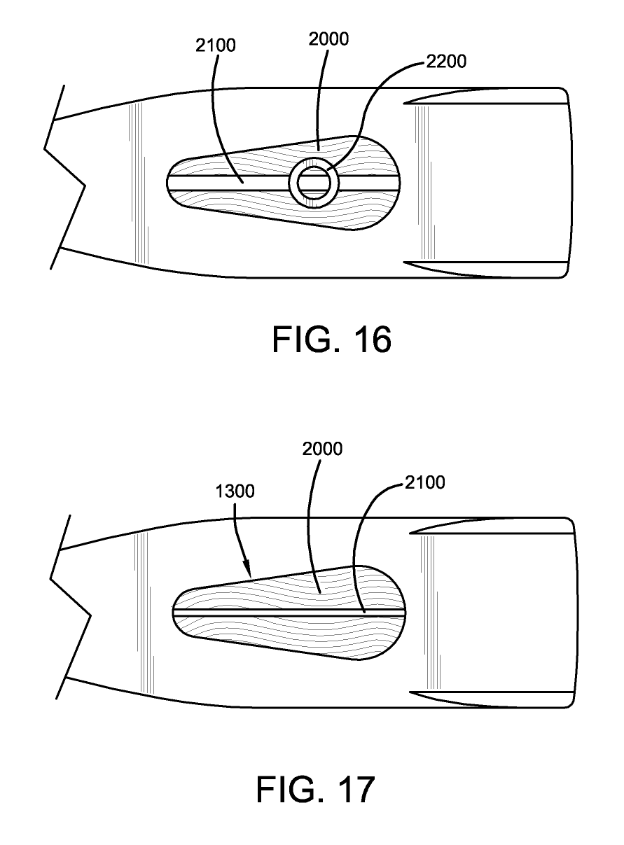

As shown in FIGS. 16 and 17, hatchet head 1050 may include an aperture 1300 configured to receive a portion of a handle 2000. In one embodiment, a first wedge 2100 and a second wedge 2200 may be driven through a longitudinal axis to expand the handle 2000 within the aperture, thereby increasing the force exerted by the handle material on the walls of the aperture 1300 and securing the handle within the hatchet head 1050. In a further embodiment, a single wedge 2100 may be used to secure the handle 2000 to the hatchet head 1050. In addition to the wedges, it is also envisioned that the handle 2000 may be further secured within the hatchet head using an adhesive, for instance a polyurethane glue.

While the disclosed subject matter has been illustrated and described in detail in the drawings and foregoing description, the same is to be considered illustrative and not restrictive in character, it being understood that only the preferred embodiments have been shown and described and that all changes and modifications that come within the spirit of the disclosure are desired to be protected.

What is claimed is:

1. A hatchet head for a roofing tool comprising:
a hammering end having striking face and a first bore formed in the striking face,
a magnet assembly disposed within the first bore including
a magnet; and
a cover having a uniform diameter along its length and retaining the magnet within the first bore; and
a multi-purpose end having a thickness, wherein an elongated slot extends through the thickness.

2. The hatchet head of claim 1, wherein the cover further includes an outer face substantially coplanar with the striking face and forming at least a portion of the striking face.

3. The hatchet head of claim 1, wherein a bore is formed in an inner face of the cover.

4. The hatchet head of claim 1, wherein the cover is frictionally fitted within the first bore.

5. The hatchet head of claim 1, wherein a depression adapted to receive a blade is formed on a first face of the multi-purpose end.

6. The hatchet head of claim 1 further comprising a pry adjacent the striking face.

7. The hatchet head of claim 1, wherein a gauging assembly is disposed through the elongated slot.

8. A roofing tool comprising:
a hatchet head having
a first end including a striking face;
a second end;
a top side;
a bottom side;
a first bore formed in the top side and adjacent to the striking face; and
a magnet assembly disposed within the first bore.

9. The roofing tool of claim 8 wherein a second bore dimensioned to receive a magnet extends below the first bore.

10. The roofing tool of claim 8, wherein the magnet assembly includes a cover adapted to retain a magnet within the first bore.

11. The roofing tool of claim 10 further comprising a magnet disposed within the first bore.

12. The roofing tool of claim 11, wherein a magnet receiving bore is formed in an inner face of the cover.

13. The roofing tool of claim 12, wherein the cover is secured within the first bore in a friction fit relationship.

14. The roofing tool of claim 8 further comprising a pry adjacent to the striking face.

15. The roofing tool of claim 8 wherein an elongated slot extends through a thickness of the hatchet.

16. The roofing tool of claim 15 wherein a gauging member is selectively disposed with the elongated slot.

17. The roofing tool of claim 8, wherein a depression adapted to receive a blade is formed on a first face of the multi-purpose end.

18. The roofing tool of claim 8, wherein the hatchet head further includes an aperture extending from the top side through the bottom side.

19. The roofing tool of claim 18 further comprising a handle at least partially disposed within the aperture.

20. A roofing tool comprising:
a hatchet head including
a hammering end having
a striking face;
a pry adjacent the striking face;
a bore formed in the striking face;
a magnet assembly disposed within the bore, wherein the magnet assembly includes a magnet and a cover retaining the magnet within the bore, the cover having a uniform diameter along its length and an outer surface substantially coplanar with the striking face;
a multi-purpose end having an elongated slot and a depression; and
an aperture formed through the hatchet head; and
a handle at least partially disposed in the aperture.
